(19) United States
(12) Patent Application Publication
(10) Pub. No.: US 2024/0167568 A1
(43) Pub. Date: May 23, 2024

(54) FRICTION FIT SEAL WITH FLANGE AND FLANGE SEALING BEAD

(71) Applicant: Parker-Hannifin Corporation, Cleveland, OH (US)

(72) Inventors: Edward B. Whitehead, Warsaw, IN (US); Timothy D. Heiman, Warsaw, IN (US)

(73) Assignee: Parker-Hannifin Corporation, Cleveland, OH (US)

(21) Appl. No.: 18/470,643

(22) Filed: Sep. 20, 2023

Related U.S. Application Data
(60) Provisional application No. 63/384,675, filed on Nov. 22, 2022.

(51) Int. Cl. F16J 15/10

(52) U.S. Cl. CPC F16J 15/106

(57) ABSTRACT

A seal includes a longitudinally-extending body configured to fit in a sealing groove of a first mating component to provide primary sealing between the first mating component and a second mating component. The longitudinally-extending body includes a first end surface located at a first end of the longitudinally-extending body, and two side surfaces that are configured to contact respective surfaces of the sealing groove. A second end surface at a second end of the longitudinally-extending body is configured to contact a sealing surface of the second mating component. The seal includes a laterally-extending flange extending from the second end of the longitudinally-extending body through a crevice between the first mating component and the second mating component. The seal includes a flange sealing bead located on a distal end of the laterally-extending flange that is configured to provide secondary sealing between the first mating component and the second mating component in the crevice.

### FIELD OF INVENTION

The present application relates generally to friction fit seals designed for narrow groove applications.

### BACKGROUND OF THE INVENTION

In several industries including, for example, automotive and heavy-duty equipment industries, sealing between various components is necessary. For serviceable sealing, elastomeric seals are preferred. With the use of such seals, however, there is a growing issue with crevice corrosion. Specifically, when moisture migrates and stagnates in a crevice between the mating components in a portion that is not fully occupied by the seal, the moisture cannot evaporate due to low temperatures common of typical applications. The presence of the trapped moisture leads to corrosion that damages the sealing surfaces of the mating components and causes leaks.

A conventional solution to such crevice corrosion includes edge molded gaskets with an extra sealing bead located on the outside. However, edge molded gaskets are expensive and are limited in their compression range. Other solutions include providing an additional sealant material in the gap, coating the surfaces of the mating components with an anti-corrosion material, or adding grease to the groove. However, additional sealants, coatings and grease may be expensive and messy to apply.

### SUMMARY OF THE INVENTION

There is a need in the art, therefore, for an improved friction fit or “press-in-place” elastomeric seal that provides effective sealing in a sealing groove as well as in a crevice between mating components, without the need for applying an additional sealant material or structurally modifying the seal retaining groove and/or mating surfaces of the mating components. In exemplary embodiments, an annular friction fit seal provides a robust sealing for large gap variation between mating components, and the friction fit seal retains itself in the groove. The continuous friction fit seal includes a longitudinally-extending body for fitting in a groove between the mating components and providing primary sealing between the mating components, and a laterally-extending flange extending into a crevice between the mating components and having a flange sealing bead for providing secondary sealing between the mating components in the crevice. The flange sealing bead prevents water and debris from entering the crevice and creating crevice corrosion, thereby preventing leakage across the seal body. The longitudinally-extending body and the laterally-extending flange including the flange bead may be provided as a single part, enabling the friction fit seal to provide both functions of sealing and preventing crevice corrosion, therefore simplifying the assembly process of the assembly and reducing cost.

An aspect of the invention, therefore, is an enhanced seal that prevents significant gaps from existing between the seal and the equipment mating components being sealed or between the mating components in a crevice when the seal is compressed. In exemplary embodiments, the seal includes a longitudinally-extending body configured to fit in a sealing groove defined by the first mating component and that provides primary sealing between the first mating component and the second mating component. The longitudinally-extending body includes a first end surface located at a first end of the longitudinally-extending body and two side surfaces. The first end surface and the two side surfaces are configured to contact respective surfaces of the sealing groove. A second end surface is located at a second end of the longitudinally-extending body and is configured to contact a sealing surface of the second mating component. The seal also includes a laterally-extending flange extending from the second end of the longitudinally-extending body. The laterally-extending flange is configured to extend into a crevice between the first mating component and the second mating component. The seal includes a flange sealing bead located on a distal end of the laterally-extending flange. The flange sealing bead is configured to provide secondary sealing between the first mating component and the second mating component in the crevice.

Another aspect of the invention is a seal assembly including the first mating component having a first mating surface that defines the sealing groove, and the second mating component having the second mating surface. The seal assembly includes the seal described above for providing both primary sealing between the first mating component and the second mating component in the sealing groove, and secondary sealing between the first mating component and the second mating component in the crevice.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto. Features that are described and/or illustrated with respect to one embodiment may be used in the same way or in a similar way in one or more other embodiments and/or in combination with or instead of the features of the other embodiments.

### BRIEF DESCRIPTION OF THE DRAWINGS

FIG. 1 is a drawing depicting a perspective cut-away view of an exemplary friction fit seal.

FIG. 2 is a drawing depicting a cross-sectional view of the friction fit seal of FIG. 1 in a seal assembly.

FIG. 3 is a drawing depicting a perspective view of the friction fit seal of FIG. 1.

FIG. 4 is a drawing depicting a cross-sectional view of another friction fit seal in another seal assembly.

FIG. 5 is a drawing depicting a cross-sectional view of another friction fit seal in another seal assembly.

### DETAILED DESCRIPTION

Embodiments of the present invention will now be described with reference to the drawings, wherein like reference numerals are used to refer to like elements throughout. It will be understood that the figures are not necessarily to scale.

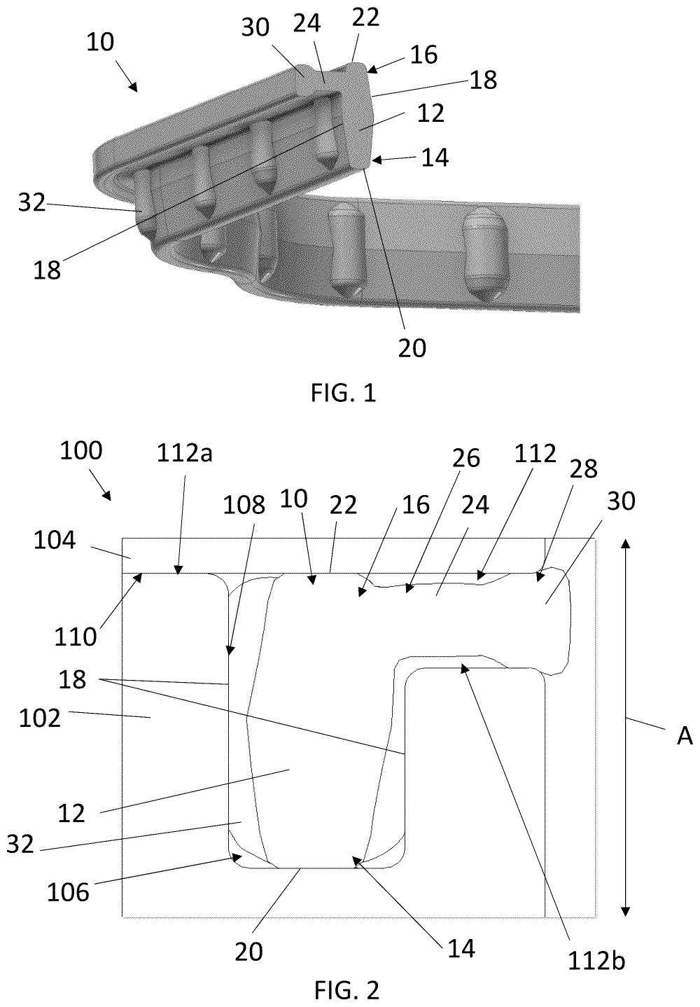

FIG. 1 is a perspective cut-away view depicting an exemplary seal 10 in accordance with embodiments of the present application, and FIG. 2 is a cross-sectional view of the exemplary seal 10 in a seal assembly 100 and in a compressed, sealed state. The seal assembly 100 includes a first mating component 102 having a first mating surface 108 defining a sealing groove 106, and a second mating component 104 having a second sealing surface 110. A crevice 112, or gap, between the first mating component 102 and the second mating component 104 extends between the first mating component 102 and the second mating component 104 on each side of the groove 106. Specifically, a first crevice portion 112a extends on a first side of the groove 106 and a second crevice portion 112b extends on a second side of the groove 106, the second crevice portion 112b extending toward a side of the groove exposed to liquid. The configuration of the seal 10 in the sealing assembly 100 provides advantages over conventional configurations by employing both primary sealing in the sealing groove 106 and secondary sealing in the second crevice portion 112b between the first mating component 102 and the second mating component 104 of the seal assembly 100, as will be described in more detail below.

With reference to FIG. 2, a longitudinal axis “A” is defined, which runs along a length or longitudinal direction of the cross-sectional face of the seal 10. The seal 10 includes a longitudinally-extending body 12 configured to fit in the sealing groove 106 and provides the primary sealing between the first mating component 102 and the second mating component 104 of the seal assembly 100. The longitudinally-extending body 12 has a first end 14 and a second end 16 opposite from the first end 14, with two side surfaces 18 extending between the first end 14 and the second end 16. A first end surface 20 located at the first end 14, and the two side surfaces 18, are configured to contact the first sealing surface 108 within the sealing groove 106. A second end surface 22 located at the second end 16 of the longitudinally-extending body 12 is configured to contact the second sealing surface 110 of the second mating component 104. The first end surface 20 and/or the second end surface 22 may be rounded, which aids in providing stability and distributing seal pressure for maximum contact surface against the components being sealed, with minimal load.

The seal 10 also includes a laterally-extending flange 24 that includes a proximal end 26 located at the second end 16 of the longitudinally-extending body 12, and the laterally-extending flange 24 extends from the proximal end 26 away from the second end 16 toward a distal end 28 opposite from the proximal end 26. The laterally-extending flange 24 is configured to extend through the second crevice portion 112b between the first mating component 102 and the second mating component 104. The second crevice portion 112b may have a gap that is larger than a gap of the first crevice portion 112a to accommodate the laterally-extending flange 24. The longitudinally-extending body 12 and the laterally-extending flange 24 may be provided as a unitary part, and, for example, may be formed as a single integrally molded component.

The seal 10 further includes a flange sealing bead 30 located on the distal end 28 of the laterally-extending flange 24. The flange sealing bead 30 is configured to provide secondary sealing between the first mating component 102 and the second mating component 104 to prevent ingress of moisture and other contaminants into the crevice 112, and particularly into the second crevice portion 112b. The flange sealing bead 30 has a thickness in the longitudinal direction that is larger than a thickness of the laterally-extending flange 24 in the longitudinal direction. Therefore, the flange sealing bead 30 is configured to contact both the first sealing surface 108 and the second sealing surface 110 in the second crevice portion 112b to block any moisture or debris from entering the crevice 112 or groove 106 between the first mating component 102 and the second mating component 104. The sealing bead 30 also may be provided as part of the unitary part constituting the longitudinally-extending body 12 and the laterally-extending flange 24.

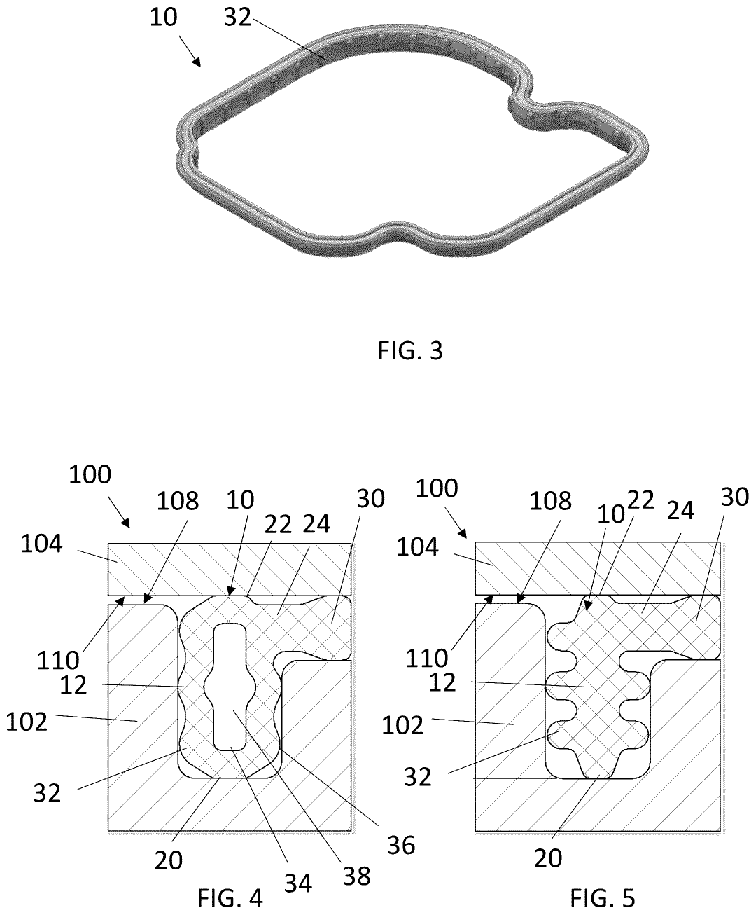

The seal 10 additionally may include at least one body bead 32 located on at least one of the two side surfaces 18 for enhancing retention and stability of the seal 10 within the sealing groove 106. The at least one body bead 32 is configured to keep the seal 10 balanced and prevent the seal 10 from rotating or rolling within the sealing grove 106 without significantly increasing load or volume fill. The at least one body bead 32 also may be configured to provide press fit interference within the narrow sealing groove 106 for good seal retention. The at least one body bead 32 may include a plurality of body beads 32. For example, as depicted in FIG. 3, the seal 10 may be annular and may include a plurality of body beads 32 spaced along the annular perimeter of the seal 10. This is also depicted in FIG. 1. The seal 10 additionally or alternatively may include a plurality of longitudinally-spaced body beads 32, as depicted in FIGS. 4 and 5. The at least one body bead 32 also may be provided as part of the unitary part constituting the longitudinally-extending body 12 and the laterally-extending flange 24.

The longitudinally-extending body 12 may be solid, as depicted in FIGS. 1, 2 and 5, or alternatively may have an inner surface 34 opposite from an outer surface 36, with the inner surface 34 defining a hollow center 38, as depicted in FIG. 4. In the exemplary embodiment illustrated in FIG. 4, the inner surface 34 may define a keyhole configuration or shape, by which seal material is absent in the center of the seal 10 so as to form the keyhole shaped configuration. For relatively low load or low-pressure applications, the keyhole configuration maintains the load low while still providing good seal pressure, and is advantageous for such applications in necessitating less material to form the seal.

The seal 10 may be made of an extruded and/or molded elastomeric material as are commonly used in sealing applications. The seal 10 may be made of any resilient compressible elastomer material that is suitable for friction-fit sealing applications, such as for example an inorganic polymer, an organic polymer, a copolymer, a fluoropolymer, a polyester, a rubber, a silicone rubber, a synthetic rubber, a vinyl polymer, or a terpolymer of ethylene. Accordingly, the sealing groove 106 may be any shape as appropriate for a given application. An example usage (non-limiting) is to seal covers for large batteries being incorporated into automotive applications, and more generally exemplary usages may include sealed housing components, lids, covers, and the like.

An aspect of the invention, therefore, is a seal configured to seal between a first mating component and a second mating component. The seal includes a longitudinally-extending body configured to fit in a sealing groove of the first mating component and provide primary sealing between the first mating component and the second mating component. The longitudinally-extending body includes a first end surface located at a first end of the longitudinally-extending body and two side surfaces. The first end surface and the two side surfaces are configured to contact respective surfaces of the sealing groove. A second end surface located at a second end of the longitudinally-extending body is configured to contact a sealing surface of the second mating component. The seal also includes a laterally-extending flange extending from the second end of the longitudinally-extending body. The laterally-extending flange is configured to extend through a crevice between the first mating component and the second mating component. The seal also includes a flange sealing bead located on a distal end of the laterally-extending flange. The flange sealing bead is configured to provide secondary sealing between the first mating component and the second mating component in the crevice. The seal may include one or more of the following features, either individually or in combination.

The seal may further include at least one body bead located on at least one of the two side surfaces of the longitudinally-extending body.

The at least one body bead may include a plurality of body beads spaced along the annular perimeter of the seal.

The at least one body bead may include a plurality of longitudinally spaced body beads.

The longitudinally-extending body may include an inner surface and an outer surface. The inner surface may define a hollow center.

The inner surface may define a keyhole shape hollow center.

The first end surface and the second end surface of the longitudinally-extending body may be rounded.

The seal may be made of an elastomeric material.

The longitudinally-extending body and the laterally-extending flange may be provided as a unitary part.

The at least one flange sealing bead and the laterally-extending flange may be provided as a unitary part.

The at least one body sealing bead and the longitudinally-extending body may be provided as a unitary part.

The seal may be annular.

Another aspect of the invention is a seal assembly including a first mating component having a first mating surface that defines a sealing groove and a second mating component having a second mating surface. The seal assembly also includes the seal according to any combination of one or more of the above paragraphs.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A seal configured to seal between a first mating component and a second mating component, the seal comprising:
a longitudinally-extending body configured to fit in a sealing groove of the first mating component and provide primary sealing between the first mating component and the second mating component, the longitudinally-extending body including a first end surface located at a first end of the longitudinally-extending body and two side surfaces, the first end surface and the two side surfaces configured to contact respective surfaces of the sealing groove, and a second end surface located at a second end of the longitudinally-extending body configured to contact a sealing surface of the second mating component;
a laterally-extending flange extending from the second end of the longitudinally-extending body, the laterally-extending flange configured to extend through a crevice between the first mating component and the second mating component; and
a flange sealing bead located on a distal end of the laterally-extending flange, the flange sealing bead configured to provide secondary sealing between the first mating component and the second mating component in the crevice.

2. The seal according to claim 1, further comprising at least one body bead located on at least one of the two side surfaces of the longitudinally-extending body.

3. The seal according to claim 2, wherein the at least one body bead includes a plurality of body beads spaced along an annular perimeter of the seal.

4. The seal according to claim 2, wherein the at least one body bead includes a plurality of longitudinally spaced body beads.

5. The seal according to claim 1, wherein the longitudinally-extending body includes an inner surface and an outer surface, and the inner surface defines a hollow center.

6. The seal according to claim 5, wherein the inner surface defines a keyhole shape hollow center.

7. The seal according to claim 1, wherein the first end surface and the second end surface of the longitudinally-extending body are rounded.

8. The seal according to claim 1, wherein the seal is made of an elastomeric material.

9. The seal according to claim 1, wherein the longitudinally-extending body and the laterally-extending flange are provided as a unitary part.

10. The seal according to claim 1, wherein the at least one flange sealing bead and the laterally-extending flange are provided as a unitary part.

11. The seal according to claim 2, wherein the at least one body sealing bead and the longitudinally-extending body are provided as a unitary part.

12. The seal according to claim 2, wherein the seal is annular.

13. A seal assembly comprising:
a first mating component having a first mating surface that defines a sealing groove;
a second mating component having a second mating surface; and
the seal according to claim 1.
